(19) United States
(12) Patent Application Publication
(10) Pub. No.: US 2006/0267767 A1
(43) Pub. Date: Nov. 30, 2006

(54) Diagnostic method as well as diagnostic device for an animal identification system, especially an animal identification system of a milking installation and milking installation with an animal identification system

(76) Inventors: Manfred Pohlkamp, Oelde (DE); Peter Kaever, Oelde (DE)

Correspondence Address: SMITH LAW OFFICE, 440 SCIENCE DR., SUITE 302, MADISON, WI, 53711, US

(21) Appl. No.: 11/406,760

(22) Filed: Apr. 19, 2006

(30) Foreign Application Priority Data
Apr. 20, 2005 (DE) 10 2005 018 402.2

(51) Int. Cl. G08B 13/14

(52) U.S. Cl. 340/572.1; 340/10.1; 340/5.8

(57) ABSTRACT

For verification of the functionality of an animal identification system, especially of an animal identification system of a milking installation, whereby the animal identification system [has] at least one transponder which is suitable for and is designed for transmitting of signals which contain preferably at least the code of one individual animal, and with at least one piece of read-in equipment for receiving signals and preferably for recognition of codes, a method is proposed in which at least one characteristic quantity is determined from the signals received during an identification period and this characteristic quantity is compared with a target quantity.

The object of the invention refers to diagnostic methods as well as to a diagnostic device for an animal identification system, especially an animal identification system of a milking installation and to a milking installation with an animal identification system.

Methods and devices for systematic tracking of events taking place in the production process for an animal yielding meat or milk from its fertilization to its utilization are known. Thus, for example, WO 99/045761 describes a method for the detection of livestock information. For this purpose each animal is marked with a radio frequency identification transponder, so that the transponder sends a unique code when it is queried by a radio frequency identification reading equipment. This code characterizes a certain animal so that each animal can be identified. At the time of an event, the unique animal code is read and is sent to a central computer.

The marking of animals with radio frequency identification transponders is a method which has been known for a long time. The characterization of animals within an animal herd has different goals. With the animal being identifiable, the economy of an animal husbandry operation can be checked. Especially in dairy farming operations, the assignment of the milk output to individual animals is of importance.

The identification of animals in combination with their history is also of great importance from the aspect of food safety and consumer protection in animals which provide foods or which are processed to foods. The possibility of tracing back the meat on the market to a group of animals is indispensable for product recalls. Therefore, regulations have been issued regarding the obligation of marking, for example by the European Union, in order to make it possible to track the beef back to the original animal. Regulation (EG) No. 820/97 prescribes, for example, the use of ear tags for individual marking.

Such ear tags are also used for animals which produce milk. In order to protect the consumer, and for technical processability, the milk must satisfy national as well as international quality requirements. Therefore, the raw milk must not have any abnormal sensory characteristics. Therefore, it is necessary to identify the animals the milk of which is not suitable, especially for human consumption. The respective identification of the animals is also of great importance when performing milking procedures. In particular, it is important that animals be appropriately identified and directed to the correct milking stations. If this is not done, then the animal-related data are incorrectly indicated at the milking station, which leads to the fact that animals whose milk should not go into the tank can still be mixed with the usable milk.

It is also known that the transponder can transmit data on individual animals. These data on individual animals can be, for example, the temperature and/or the activity of an animal. The measurement of temperature and/or the measurement of the activity is especially important in the case of cows to enable recognition of estrus. Estrus involves a change of various physiological parameters and also results in a change in the behavior of the animal. Thus, for example, transponders are known which also transmit data from electronic step counters which detect the activity of a cow automatically.

The identification of animals is significant not only in connection with a milking process, but also, for example, in connection with the feeding of animals. Such systems are used, for example, in weighing systems with identification. Erroneous identification of an animal can lead to the fact that no animal weight is obtained. A treatment station with identification would not administer the required medication if the identification is inappropriate. In feeding devices, the problem can occur that no food is dispensed for animals which are not recognized. As a result of this, in extreme cases, undersupply of the nonrecognized animal can occur which can lead to metabolic problems. Erroneous or inappropriate identification of animals can therefore lead to not insignificant economical consequences for an animal husbandry operation, especially for a dairy farming operation.

Based on this, the task of the invention is a diagnostic method for an animal identification system, especially for an animal identification system of a milking installation, through which the operation of the animal identification system can be checked.

According to the invention, this task is solved by a diagnostic method for an animal identification system, especially for an animal identification system of a milking installation with the characteristics of claim 1. Advantageous further developments and embodiments of the diagnostic method are the objects of the dependent claims.

The diagnostic method for an animal identification system, especially for an animal identification system in a milking installation, where the animal identification system contains at least one piece of reading equipment for detecting the information, especially information which contains at least one code of an individual animal, is characterized by the fact that from the detected information of at least one detection process, at least one characteristic quantity is determined, and this characteristic quantity is compared with a target quantity. With the aid of this method the possibility is created of checking the functionality of the animal identification system. Thus, it can be determined even at an early point in time if and to what extent a dysfunction exists in the animal identification system. The detection process can be a process in which the animals are detected individually. Hereby individual characteristic quantities are formed which can be assigned to the individual animals or identification means that are carried by the animals. It is also possible to form group-specific characteristic quantities. Such a possibility is especially of interest when the identification means that are carried by the animals have different functionalities and/or are made by different manufacturers. Moreover, it is possible to form group characteristic quantities and also herd characteristic quantities in addition to individual characteristic quantities. Assuming that a coincidental improvement of an animal identification system does not occur, the identification rates will become worse, for example due to failure of transmitters and/or reading equipment, so that a global consideration, for example of herd-specific quantities and/or group characteristic quantities can represent a first step of approximation in the diagnostics of the animal identification system.

The characteristic quantities can also be derived and evaluated from the history of the identification. Especially, using stochastic and/or heuristic methods, the source of error can be found in case of an adverse change of the characteristic quantities. The target quantity with which a characteristic quantity is compared can be formed by deriving these, for example, from the known number of animals which are to be identified. For example, animal data are present in a so-called herd management system in a diary farming operation. These data contain the animal identification and optionally may contain the activity of each animal. Such information is transmitted, for example, to a central control device. The control device contains data during each milking process regarding the animals to be milked. If during the identification of the animals at the beginning of the milking process it is found that the number of identified animals is smaller than the number of animals to be milked, then, from this, one can generate the information that there is an erroneous function in the animal identification system. Optionally this erroneous functioning of the animal identification system can be defined as a function of a tolerance field. In case of erroneous functioning of the animal identification system, the erroneous function may be, for example, that of the laser equipment. There is also a possibility that the erroneous function is due to a transmitter, especially a transponder. Moreover, it is also possible that a transmitter, especially a transponder, became lost.

The target characteristic quantity can be provided, for example, by a herd management system. The herd management system contains the data of the individual animals of a herd.

The target characteristic quantity can also be formed by passing the animals of a herd through the animal identification system and then storing the read data of the individual animals in a database. These data are used to form at least one target quantity.

The identification behavior of the animal identification system can be influenced by different factors. Thus, for example, the identification rate may change as a result of external influences, for example dirt, moisture and technical problems of the transponder. Therefore, it is proposed that the time course of at least one characteristic quantity be compared with the course of the target quantity. A change in the identification quality is detected by this measure.

In case of an unsteady drop of the identification quality it can be determined that the [worsening] occurred, for example, due to changes in the area of the animal identification system. The animal identification systems are installed in the area of through-ways or inlet gates. As a result of additional structures, the identification field or the antenna field can be worsened, which leads to worsened identification of the animals. By verification of the time course of at least one characteristic quantity, it can be seen that, for example, the magnetic field of the read-in equipment is adversely influenced when using an inductively coupled transponder. Inductively coupled transponders are almost exclusively operated in a passive manner. This means that the entire energy necessary for the operation of a microchip contained in the transponder must be made available through the read-in equipment. For this purpose the antenna coil of the read-in equipment uses a strong high-frequency electromagnetic field which penetrates through the cross-section of the trace surface and penetrates through the space around the coil. A small part of the emitted field penetrates through the antenna coil of the transponder which is located at some distance from the coil of the read-in equipment. As a result of this a voltage is produced at the antenna coil of the transponder by induction. This voltage serves to supply energy to the data carrier which is a microchip. By an adverse influence on the antenna field, errors may occur in the identification of the animals. Non-continuous changes in the time course of at least one characteristic quantity can be used advantageously for obtaining conclusions about abrupt changes in the identification system or in the structures neighboring the identification system.

According to yet another advantageous embodiment of the diagnostic method, it is proposed that at least two pieces of read-in equipment be provided whereby at each read-in equipment location at least one read-in-equipment-dependent characteristic quantity is determined. In this way redundant systems can be constructed. The read-in-equipment-dependent characteristic quantities can be compared with the target quantity. Deviations in these comparisons can lead to conclusions about the identification quality of the read-in equipment. For example, if two pieces of read-in equipment are provided and these two read-in instruments yield different identification rates, then, from the difference of the identification rates when these are outside a tolerance range, it can be concluded that the functionality of the read-in equipment which provides the smaller identification rate has been adversely influenced, in comparison to the other read-in equipment. A method is preferred that adjusts the target values or characteristic quantities to the different constellations in which the components of the animal identification system are installed.

In order to reduce the expenditure involved in comparing several pieces of read-in equipment, it is proposed that the read-in-equipment-dependent characteristic quantities be compared to one another. As a result of, this direct comparison of the read-in-equipment-dependent characteristic quantities can be performed.

According to a further advantageous embodiment of the diagnostic method it is proposed that the time course of the read-in-equipment-dependent characteristic quantities be compared with a target quantity or with one another. As a result of this, changes can be verified during the operation of the animal identification systems.

The identification rates are dependent first of all on the functionality of the transponder and also on the functionality of the read-in equipment. In order to be able to check or diagnose the functionality of the transponder, it is proposed that the read-in equipment measure the field strength with which the transponders can be identified so that as a result of this there will be a detailed possibility of evaluation of quality or evaluation of diagnosis.

According to yet another advantageous embodiment of the diagnostic method, it is proposed that the intensity of the signals of the transponder be measured and stored. These intensities can also be used to form a characteristic quantity. Through the measurement and determination of the intensity of the signals of the transponders, the properties of the individual transponders can be determined. Moreover, when recording the intensity of the signals of the transponder over several identification processes, the course of these intensities can be verified. The measurement and determination of the intensity of the transponder signals therefore opens up the possibility of providing time values for the individual transponders that can be represented and evaluated as a function of time too. The indicated changes can refer to a change in comparison to the last measured value, for example at the last milking, or to changes in comparison to mean values, for example over several identification periods.

An embodiment of the diagnostic method is preferred in which during a registration process the transponders are scanned several times. Since the field intensity with which a transponder is recognized when passing through the antenna field is subject to fluctuation, multiple scanning of a transponder is performed. As a result of this, it is also ensured that the transponder is registered from the antenna field with a sufficiently high intensity. In such a process it is preferred that the maximum values of the signals be stored. Here we are dealing with maximum values of the signal during a registration process. If the maximum values of the signals are stored through several registration processes, then from this the time course of the maximum values can be represented and used for diagnostic purposes. From the course of the maximum values, when the read-in equipment is of constant quality, one can derive conclusions regarding the quality of the transponder, especially when the statistical health is taken into consideration.

The possibility also exists of determining a mean intensity of the signal of at least one transponder from a multiple number of registration processes. The number of identification periods can be predetermined freely.

In order that missing identification not have an adverse influence on the statistical evaluation of the signal, there is a possibility of omitting these.

The diagnostic method according to the invention makes it possible to make a diagnosis of the components of the animal identification system. First of all, the possibility is created to provide information about the quality of the read-in equipment with the aid of the diagnostic procedure. Moreover, the animal identification is influenced by the functionality of the transponder. This influence can be verified by the diagnostic process so that by means of the diagnostic process the functionality of the identification system can be evaluated. If it is possible to identify the field strength of the transponder, then an automatic quality evaluation of the transponder is also possible. Especially, the possibility is created for storing the signal intensity of a transponder as a function of the read-in equipment too. On the one hand it is possible in this way to determine the mean signal intensity of the identification of a transponder. This permits direct conclusion about the quality of each transponder and it is especially favorable when the transponder is recognized by various read-in equipment. Qualitatively defective or poorly attached transponders are recognized with read-in equipment with signal intensities which lie below that of a properly attached and defect-free transponder. Thus, deviations can be detected immediately. Based on the stored data, as well as through knowledge of the different transponders, a statistical evaluation of the different transponders can also be performed. Therefore, using the available data, it is possible to determine the quality separately according to transponder type, whereby especially the mean value of all quality data of all transponders is formed as a function of the transponder type.

Especially, individually transponders of poor quality can be identified in the herd management program and indicated.

In order to exclude influences of the read-in equipment, it is expedient to take into consideration the identification quality of the individual read-in equipment. This makes sense especially when read-in equipment of very different types are present in an animal identification system and these have identification qualities depending on their construction. Thus, these different identification qualities can be taken into consideration in a statistical evaluation using the corresponding correction factors.

Another task on which the present invention is based is to provide a diagnostic device for an animal identification system, especially for an animal identification system of a milking installation, with the aid of which the functionality of the animal identification system can be verified.

According to the invention, this task is solved with a diagnostic device for an animal identification system, especially for an animal identification system of a milking installation with the characteristics of claim 14. Advantageous further developments and embodiments of the diagnostic device are the object of the dependent claims.

The diagnostic device according to the invention for an animal identification system, especially for an animal identification system of a milking installation, whereby the animal identification system comprises at least one piece of read-in equipment for recording of information, especially of information which contains at least one code of an individual animal, is characterized by the fact that a device is provided for forming at least one characteristic quantity based on the signals. Using signal technology, the device can be connected to a read-in equipment. Especially, there is a possibility of bidirectional communication between the device and the read-in equipment. Using a comparison device, a comparison is performed of at least one characteristic quantity and at least one target quantity. The diagnostic device can be a stationary and/or a mobile unit. Preferably it is realized as a component of the herd management system.

The signal-technological connection between at least one piece of read-in equipment and the device can be wireless or done with wires. In order to be able to evaluate the quality of the animal identification with the animal identification system also in a time-relationship, it is proposed that the diagnostic device be designed so that the device and/or the comparison device has at least one memory unit. The device, the comparison device as well as the memory unit can be realized with a computer.

Preferably the device is designed so that it can be connected to at least two pieces of read-in equipment.

In order to output the data, the diagnostic device has a data output device which is connected to the comparison unit. The data output device can be an optical and/or acoustical data output device. With the aid of this data output device, for example a warning signal or a warning display can be created when it is found that the identification rate of the animal identification system falls below a certain value. The output device can also be realized with a printer or monitor.

According to still another inventive idea, an animal identification system, especially an animal identification system of a milking installation is proposed, whereby the animal identification system has at least one diagnostic device according to one of claims 14 to 19.

Preferably, the animal identification system has a transmitter, which is most preferably a transponder.

According to a still further inventive idea, a milking installation with an animal identification system is proposed, whereby the milking installation has at least one diagnostic device according to one of claims 14 to 19.

A design of a milking installation is preferred in which the animal identification system is created according to claim 20 or 21. According to an advantageous embodiment of the milking installation it is proposed that the diagnostic device be connected to a control device of the milking installation using data technology.

A design of the milking installation is especially preferred in which the diagnostic device and/or the animal identification system can be connected to a herd management system.

The diagnostic method according to the invention, the diagnostic device according to the invention, the animal identification system according to the invention as well as the milking installation according to the invention can have milking parlors which are partially automatic or semi-automatic or fully automatic or even robot supported. The invention can be used anywhere where animals have to be identified safely and reliably. The animals can be cows, sheep, goats, buffalo, dromedaries, mares, yaks or others, especially animals that provide milk.

The transponders can be carried as bolus, ear tags, injectates or as conventional transponders attached to the foot or neck, in the rumen, at the udder or at the teat, or subcutaneously or in other suitable locations. This applies to transponders which are carried permanently or temporarily by the animal. In addition to the data on individual animals, the transponders can also transmit other sensory functions, which can be for example activity values, pH values or temperature values. Furthermore, sensory values or other values can also be transmitted with the transponder. The contactless communication between the transponder and a read-in equipment can operate according to the radio frequency method (RF method). However, it is also possible to operate the transponder and read-in equipment in the microwave region.

The data transfer from transponder in the direction of the read-in equipment can be done with the half-duplex (HDX) method. In a half-duplex method the data transfer occurs displaced in time. Hereby the data are transmitted in the MHz range.

When the data transfer from transponder in the direction in the read-in equipment occurs essentially simultaneously with the data transfer from read-in equipment to transponder, then the full-duplex (FDX) method is used. Hereby methods are used in which the data of the transponders are transmitted on partial frequencies of the read-in equipment, that is, on a subharmonic or at a completely independent frequency, that is, at an anharmonic frequency, to the read-in equipment. Especially, the so-called RFID systems can be used for animal identification.

Other details and advantages of the invention will be explained with the aid of the practical examples shown in the drawing, without the object of the invention being limited to these practical examples.

The following are shown:

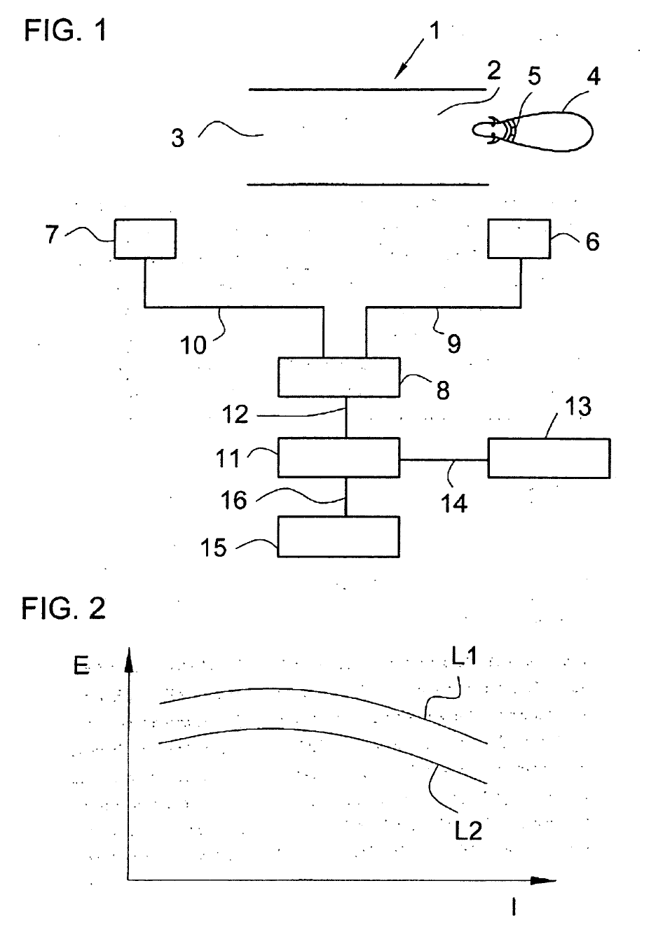

FIG. 1 is a schematic illustration of a diagnostic device for an animal identification system in a milking installation,

FIG. 2 shows the course of the identification rates of two pieces of read-in equipment over identification periods

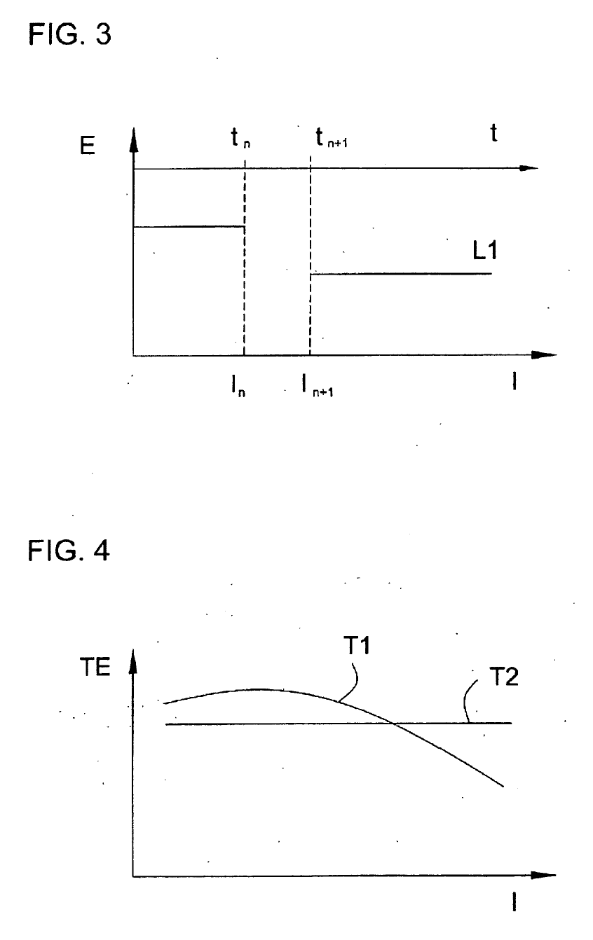

FIG. 3 is a schematic illustration of the course of an identification rate of read-in equipment,

FIG. 4 is a schematic illustration of the course of the identification rates of transponders through the identification periods,

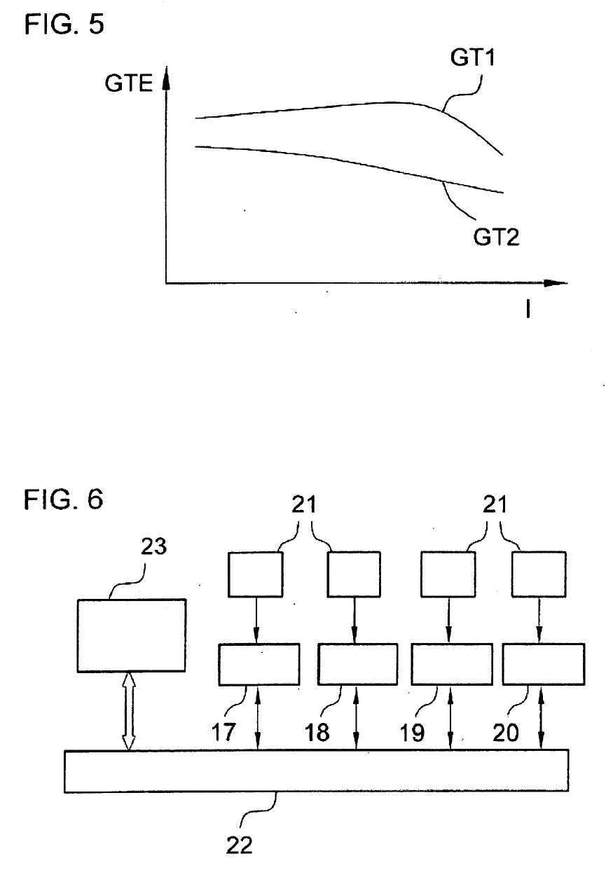

FIG. 5 is a schematic illustration of the course of the identification rates of two groups of transponders of the identification periods,

FIG. 6 is a schematic illustration of a block diagram of an animal identification system in connection with a diagnostic device in a milking installation, and

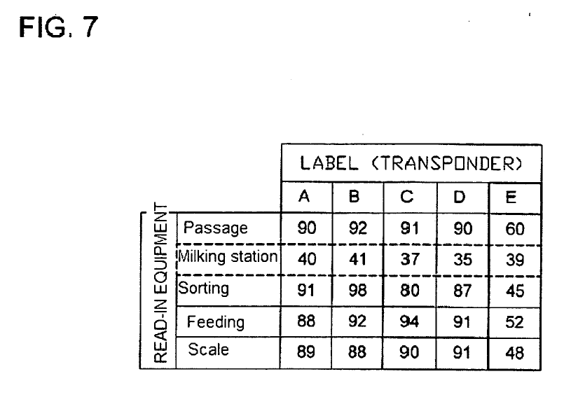

FIG. 7 is a schematic illustration of a table of label identifications.

FIG. 1 shows schematically a diagnostic device with an animal identification system in a milking installation. The representation and the explanation relating to the representation will explain below the fundamental functioning and the structure without limiting the object of the invention to this concrete practical example.

Reference number 1 indicates a passage which has an entry 2 and exit 3. The passage 1 can lead, for example, to a milking area or to a milking parlor. It can also be a part of a sorting or a feeding device. Within the passage a scale can also be provided with the aid of which the weight of the animal is determined.

Each animal 4 enters the passage through entry 2 and leaves it through exit 3. The animal has a transponder 5. The transponder is located at the neck. Instead of a transponder 5 at the neck, the animal 4 may also have other means of identification. Thus, for example, a bolus, an ear tag or an injectate can be used. The means of identification can be attached permanently or temporarily to the animal. The transponder 5 contains information about the individual animal. This can be the identification of the animal. Moreover, with the aid of the transponder, sensory data of the animal can be transmitted. Especially these are activity data, pH value or temperatures of the animal. Such data are especially of interest in order to recognize the estrus of an animal.

Read-in equipment 6 is first provided in the region of entry 2. Using the first read-in equipment 6, the data from transponder 5 of each animal that passes by the read-in equipment 6 are read out. In the practical example shown, a second read-in device 7 is provided in the region of exit 3. Also by means of this read-in device 7, information about the animals 4 is read out of the transponders 5.

The first read-in equipment and the second read-in equipment 6, 7 can also be arranged next to one another, but here it must be ensured that the read-in equipment 6, 7 do not perturb each other.

The first read-in equipment 6 is connected to a device 8 through a signal line 9. The second read-in equipment 7 is also connected to the device 8 via a signal line 10. The data of transponder 5 selected by read-in equipment 6, 7 are transmitted to device 8 as signals. Characteristic data are formed based on the signals. In the simplest case, the number of animals identified by the first and second read-in equipment is formed during a registration process. The characteristic quantity or characteristic quantities formed in the device are transmitted to a comparison device 11 through a line 12. In the comparison device 11, a comparison of the characteristic quantities with at least one target quantity is performed. Depending on the comparison, an acoustic and/or optical signal is emitted, for example through a data output device 15, which is connected to the comparison device 11 via line 16, which shows, for example, that the identification rate is below a certain value.

In the practical example shown in FIG. 1, the comparison device 11 is connected to a herd management system 13 via a data line 14. The herd management system 13 has the data of individual animals deposited so that in the comparison device 11 a calibration between the identification rates of the recognized animals can take place. Such a calibration is especially of interest when, for example, during a registration process an animal may enter the identification system several times. In a global consideration of the identification rates, this would result in a falsification of the results, so that an animal which is registered more than once by an identification system is taken into consideration only once.

FIG. 2 shows a diagram of the identification rates E of two pieces of read-in equipment L1 and L2. It can be seen from the diagram that the identification rate of read-in equipment L1 and L2 [shows] a multiple number of registration processes 1. In the practical example shown, the identification rate of read-in equipment L1 is larger than the identification rate of read-in equipment L2. In both read-in equipment L1 and L2 the identification rate decreases as a function of the number of registration processes. The reason for this decrease can be, for example, a decrease of the performance of transponder 5, for example, due to penetration of moisture into the transponder.

It can be seen from the diagram according to FIG. 3 that the identification rate of read-in equipment L1 is at a constantly high level up to registration process Iₙ, whereas starting from registration process Iₙ₊₁ the identification rate becomes suddenly lower and then remains constant during the subsequent registration processes. From such a course of the identification rate of read-in equipment L1, it can be concluded that during the time period tₙ to tₙ₊₁ a change occurred within the animal identification system or in the surroundings of the animal identification system. Thus, for example, the identification rate of a read-in equipment can be influenced adversely by the installation of new steel structures.

While in the diagrams according to FIGS. 2 and 3 the rough identification rates are shown, FIG. 4 gives the fine identification rates of individual transponders T1 and T2.

If the read-in equipment is designed so that it is suitable for and is designed for identifying the field strength of the transponder, then a quality evaluation of the transponder can be performed based on the field strength of the individual transponder. FIG. 4 shows a representative sample of the course of the transponder identification rates of transponders T1 and T2. While the transponder identification rate of transponder T2 is constant, the identification rate of transponder T1 decreases through a multiple number of registration processes. It can be concluded from this that the performance of transponder T1 became worse. When the identification rate of transponder T1 reaches a predetermined threshold value or target value, an alarm can be triggered so that this transponder will be replaced.

The animals of a herd can be provided with transponders of a different construction type or also with transponders of the same type but made by different manufacturers. Transponders of the same construction type or of the same manufacturer can be combined to groups. The combining of these transponders to groups makes it possible to evaluate the quality of identification and the performance of the different groups. From a multiple number of transponders which belong to a group, one can derive a characteristic quantity for each identification period, which reflects the identification rates of all transponders which belong to a group. Here we can speak of a group transponder identification rate (GTE). Such a group transponder identification rate can be determined, for example, by forming a mean value of the identification rates of the individual transponders which belong to a group. As an example, FIG. 5 shows the course of the identification rates of the group of transponder T1 and the group of transponder T2. From this, information is obtained about the behavior of the groups and thus also an evaluation of the quality of identification of the different transponders can be determined, whereby this evaluation has a broad base.

The automatic measurement of the identification performance can be realized within a herd management related to the read-in equipment on the one hand and related to the transponders on the other hand. Preferred statistical methods are used for this, especially stochastic and/or neumastic [sic] methods. With these methods, the quality of the animal identification system can be verified. Characteristic quantities can be formed and evaluated. Significant deviations can moreover trigger an alarm situation. Especially, changes of the characteristic quantities may lead to the fact that these are indicated to the operator so that continuous control of the animal identification system becomes possible.

Animal identification systems are known which perform a self-calibration regarding environmental conditions, and this occurs automatically as a rule. The boundary conditions of the animal identification system which were altered as a result of such self-calibration are preferably transmitted to a central control unit in order to derive from these data a measure for the changes of the components of the animal identification system itself and optionally changes in the structure of milking parlors or similar. Especially, by corresponding measures, such a self-calibration can be blocked in order to ensure that during a registration process no automatic calibration occurs because during such a self-calibration identification is not possible or is possible only to a limited extent.

When a self-calibration occurs then this must be taken into consideration in the determination of the identification rates for the future. Optionally, the time at which the self-calibration occurred is marked correspondingly. Optionally, the self-calibration factors can be used for the determination of a compensated identification rate. Especially, the values obtained during self-calibration can be used in the calculation of a new start value.

Adjustment with the aid of the first newly determined data of the identification quality is thereby also possible. Also, by combination of the calibration processes with measurement of the quality of the components of the animal identification system, the system and the process can be meaningfully expanded. Thus, for example, it is possible that the self-calibration is controlled by a central control unit, when certain identification rates of the animal identification system reach a lower threshold value.

For example, FIG. 6 shows a block diagram of an animal identification system in a dairy operation. Reference number 17 to 20 indicate units in which an animal identification takes place. In this connection, these can be an animal identification in the milking parlor area, feeding area, sorting area and/or weighing area. The transponder 21 of the animals which are identified by the corresponding animal identification system provide information to an information device 22 which works in cooperation with a herd management system 23. The information device 22 may also contain control components, so that the individual areas 17 to 22 are controlled in a manner corresponding to the operational processes.

FIG. 7 shows a table. In this, identification stations are given as well as the signal intensities recorded for the individual labels A to E. It can be seen from the table that, for example, the signal intensity of label E is significantly smaller in comparison to the signal intensities of the other labels. It can be concluded from this that the label (transponder) exhibits insufficient functionality.

Furthermore, it can be seen from the table that, for example, the signal intensities for all labels at the milking station are smaller than at the other identification stations. It can be concluded from this that the read-in equipment's functionality is at least impeded.

### REFERENCE LIST

1. Passage

2. Entry

3. Exit

4. Animal

5. Transponder

6. First read-in equipment

7. Second read-in equipment

8. Device

9. Signal line

10. Signal line

11. Comparison equipment

12. Line

13. Herd management system

14. Date line

15. Data output device

16. Line

17. to 20.Area

21. Transponder

22. Information device

23. Herd management system

1. A diagnostic method for an animal identification system, whereby the animal identification system has at least one read-in equipment for recording information, of at least one code of an individual animal, in which from the recorded information of at least one registration process at least one characteristic quantity is determined and this characteristic quantity is compared with a target quantity.

2. The diagnostic method according to claim 1, in which the time course of at least one characteristic quantity is compared with the course of the target quantity.

3. The diagnostic method according to claim 1, in which at least two pieces of read-in equipment are provided and whereby to each read-in equipment at least one read-in-equipment-dependent characteristic quantity is determined.

4. The diagnostic method according to claim 3, in which the read-in-equipment-dependent characteristic quantities are compared with each other.

5. The diagnostic method according to claim 3, in which the time course of the read-in-equipment-dependent characteristic quantities are compared with at least one target quantity.

6. The diagnostic method according to claim 1, in which the information is recorded optically.

7. The diagnostic method according to claim 1, in which the information of at least one transmitter especially a transponder is transmitted to the read-in equipment.

8. The diagnostic method according to claim 7, in which the intensity of the signals of the at least one transmitter is determined, measured, and stored.

9. The diagnostic method according to claim 7, characterized by the fact that at least one transponder is scanned a multiple number of times during a registration process.

10. The diagnostic method according to claim 8, characterized by the fact that always the maximum values of the signals are stored.

11. The diagnostic method according to claim 8, in which the time course of the intensity of the signals of at least one transmitter is provided.

12. The diagnostic method according to claim 7, in which, from a multiple number of registration processes, a mean intensity of the signals of at least one transmitter is determined.

13. The diagnostic method according to claim 1, in which the characteristic quantities are compared.

14. A diagnostic device for an animal identification system, where the animal identification system has at least one piece of read-in equipment for registering a code of one individual animal, characterized by a device which can be connected with signal technology to at least one piece of read-in equipment to form at least one characteristic quantity based on the recorded information and by a comparison device for comparing at least one characteristic quantity with at least one target quantity.

15. The diagnostic device according to claim 14, characterized by the fact that the device has at least one memory unit.

16. The diagnostic device according to claim 14, characterized by the fact that the device can be connected to at least two pieces of read-in equipment.

17. The diagnostic device according to claim 14, characterized by the fact that a data output device is provided which is connected to the comparison equipment.

18. The diagnostic device according to claim 14, characterized by the fact that at least one piece of optically operating read-in equipment is provided.

19. The diagnostic device according to claim 14, characterized by the fact that at least one piece of read-in equipment is designed as a receiver.

20. (canceled)

21. (canceled)

22. (canceled)

23. (canceled)

24. (canceled)

25. (canceled)
